(19) United States
(12) Patent Application Publication
(10) Pub. No.: US 2009/0124279 A1
(43) Pub. Date: May 14, 2009

(54) Method and system for activating a backup radio frequency transmitter

(75) Inventor: Anthony Guerra, Brampton (CA)

Correspondence Address: WEINGARTEN, SCHURGIN, GAGNEBIN & LEBOVICI LLP, TEN POST OFFICE SQUARE, BOSTON, MA, 02109, US

(73) Assignee: Rogers Communication Inc., Toronto (CA)

(21) Appl. No.: 11/983,379

(22) Filed: Nov. 8, 2007

(51) Int. Cl. H04Q 7/30

(52) U.S. Cl. 455/525

(57) ABSTRACT

A method and system for activating a backup radio frequency transmitter based upon a status of a primary radio frequency transmitter, the backup radio frequency transmitter being controllable by a backup control device. The method comprises providing a primary control device, receiving in the primary control device from the primary radio frequency transmitter status information relating to the primary radio frequency transmitter, generating a data message from the status information, and sending the data message information to the backup control device over an Internet Protocol based network for processing by the backup control device. The method may also include receiving the data message in the backup control device over the Internet Protocol based network, and activating the backup radio frequency transmitter using a control signal from the backup control device based upon the data message.

### FIELD

Example embodiments described herein relate to radio frequency transmitter systems, and in particular to radio frequency transmitter systems having backup radio transmitter sites.

### BACKGROUND

In typical commercial radio stations, a radio frequency (“RF”) signal is fed to an RF transmitter that amplifies and conditions the signal in some manner before feeding it to an antenna network. If the transmitter fails, there is typically a backup transmitter at a remote location that may be activated.

Transmitter sites are typically equipped with metering and control systems. Such metering and control systems provide a number of inputs and outputs for receiving data from the RF transmitter and for outputting commands. Some systems are designed with an interactive voice response interface capable of receiving Dual Tone Multi-Frequency (“DTMF”) tones over a public switched telephone network (“PSTN”), to enable a radio engineer to access metering information or input commands remotely by telephone.

In some conventional systems, when a primary transmitter loses power or RF signal, the metering and control system sends the radio engineer an alarm message by a numeric pager. The radio engineer then accesses the system via telephone over the PSTN, and communicates with the system through the interactive voice response interface to assess the problem. The engineer then accesses a second metering and control system at a backup transmitter site to activate the backup transmitter.

Such systems may be cumbersome and labour intensive for the radio engineer. There may also be additional costs associated with operating such systems over PSTNs, which typically operate over leased PSTN lines.

In other conventional systems, a centralized switching mechanism may be used to facilitate switching between RF transmitters. In such systems, much of the decisions may also be made within the centralized switching mechanism. Switching mechanisms may also require rather complex circuitry for operation.

### BRIEF DESCRIPTION OF THE DRAWINGS

Example embodiments will now be described by way of example with reference to the accompanying drawings, through which like reference numerals are used to indicate similar features.

FIG. 1 shows an example of a radio transmitter system in accordance with an example embodiment;

FIG. 2 shows a block diagram of a control device to be used in the radio transmitter system shown in FIG. 1;

FIG. 3 shows an example graphical user interface screen shown on a display of the control device of FIG. 2, displaying a main environment;

FIG. 4 shows another graphical user interface screen shown on the display of the control device of FIG. 2, displaying a settings configuration page;

FIG. 5 shows an example graphical user interface screen, configured for a primary control device to be used in the radio transmitter system shown in FIG. 1;

FIG. 6 shows an example graphical user interface screen, configured for a backup control device to be used in the radio transmitter system shown in FIG. 1; and

FIG. 7 shows in flow chart form a method in accordance with an example embodiment.

### DETAILED DESCRIPTION

The present application provides a system for activating a backup transmitter controlled by a backup control device, the system having a primary control device for monitoring status information of a primary transmitter and for communicating the status information to the backup control device over an Internet Protocol connection.

According to one example embodiment is a method for activating a backup radio frequency transmitter based upon a status of a primary radio frequency transmitter, the backup radio frequency transmitter being controllable by a backup control device. The method comprises providing a primary control device, receiving in the primary control device from the primary radio frequency transmitter status information relating to the primary radio frequency transmitter, generating a data message from the status information, and sending the data message to the backup control device over an Internet Protocol based network for processing by the backup control device.

According to another example embodiment is a system for activating a backup radio frequency transmitter based upon a status of a primary radio frequency transmitter. The system includes a primary control device associated with the primary radio frequency transmitter and a backup control device for controlling the backup radio frequency transmitter and in communication with the primary control device over an Internet Protocol based network. The primary control device is configured to (i) receive from the primary radio frequency transmitter status information relating to the primary radio frequency transmitter, (ii) generate a data message from the status information, and (iii) send the data message to the backup control device over the Internet Protocol based network for processing by the backup control device. The backup control device is configured to (i) receive the data message over the Internet Protocol based network, and (ii) send a control signal to activate the backup radio frequency transmitter based upon the data message.

According to another example embodiment is a local control device connected to a local radio frequency transmitter and configured for communication with a remote control device connected to a remote radio frequency transmitter. The local control device includes a controller for controlling the operation of the local control device and a communications interface accessible by the controller and configured for communication with the local radio frequency transmitter and configured for communication with an Internet Protocol based network. The controller is configured to receive from the local radio frequency transmitter status information relating to the local radio frequency transmitter, generate a data message from the status information, and send the data message to the remote control device over the Internet Protocol based network for processing by the remote control device. The controller may further be configured to receive from the remote control device the data message over the Internet Protocol based network, and send a control signal to de-activate the local radio frequency transmitter based upon the data message.

According to another example embodiment is a computer readable memory having recorded thereon instructions for execution by a local control device connected to a local radio frequency transmitter, the local control device configured for communication with a remote control device connected to a remote radio frequency transmitter, the instructions including instructions to receive from the local radio frequency transmitter status information relating to the local radio frequency transmitter, generate a data message from the status information, and send the data message to the remote control device over an Internet Protocol based network for processing by the remote control device.

For clarity, references to “radio” and “radio frequency” (“RF”) may be used interchangeably, as appropriate. RF may also include carrier frequencies in both the AM range (550 to 1,700 kHz) and FM range (88 to 108 MHz).

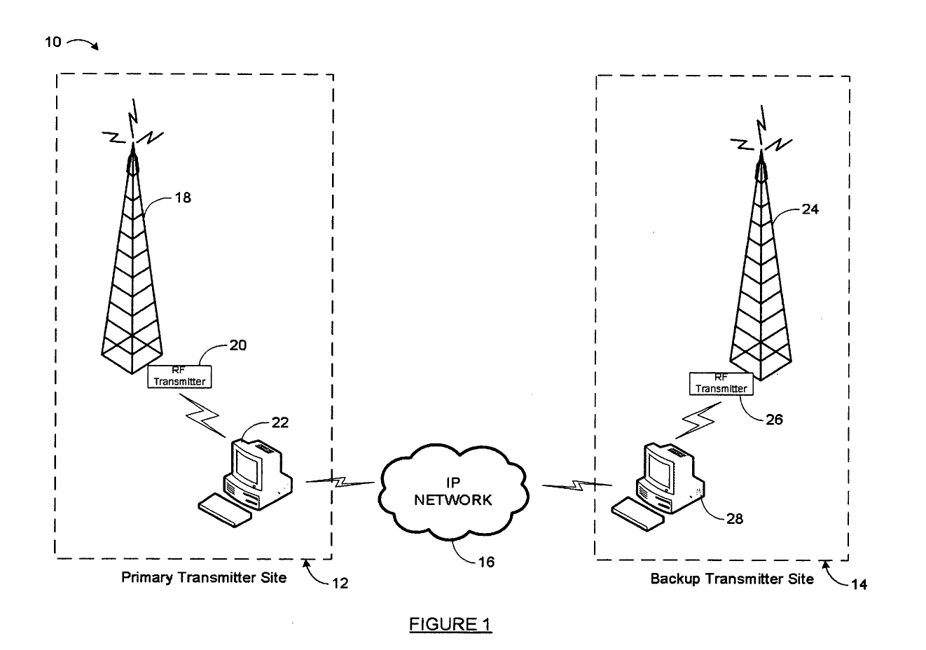

Reference is now made to FIG. 1, which shows an example of a radio transmitter system 10 in accordance with an example embodiment. The transmitter system 10 includes a primary transmitter site 12 and a backup transmitter site 14. The primary transmitter site 12 includes a primary antennae network 18, a primary RF transmitter 20, and a primary control device 22. Similarly, the backup transmitter site 14 includes a backup antennae network 24, a backup RF transmitter 26, and a backup control device 28. The transmitter system 10 includes an Internet Protocol (IP) network 16 for facilitating communication between the transmitter sites 12, 14. Information may be communicated between the transmitter sites 12, 14 by way of the IP network 16, for communicating information relating to control and monitoring of the transmitter sites 12, 14.

Referring now to the primary transmitter site 12, the primary RF transmitter 20 sends a broadcast signal via the primary antennae network 18. An RF signal may be received by the primary RF transmitter 20 for amplification and conditioning of the RF signal, as is known in the art. The RF signal may for example contain an audio broadcast signal from a commercial radio station. The primary RF transmitter 20 sends this RF signal to the primary antenna network 18, for subsequent broadcasting and transmission of the RF signal. The primary control device 22 receives status information from the primary RF transmitter 20, and is also configured for communication with the IP Network 16. Referring now to the backup transmitter site 14, the backup transmitter site 14 provides an alternate broadcasting and transmission of the RF signal in case of a fault in the primary transmitter site 12, such as a power outage or loss of RF signal. In some embodiments, the backup transmitter site 14 is located geographically remote from the primary transmitter site 12. In some example embodiments, the backup transmitter site 14 broadcasts to generally the same geographical region as the primary transmitter site 12. With respect to the backup transmitter site 14, a similar configuration is shown with respect to the backup antennae network 24, the backup RF transmitter 26, and the backup control device 28.

In some example embodiments, the primary control device 22 is configured to (i) receive from the primary radio frequency transmitter 20 status information relating to the primary radio frequency transmitter 20, (ii) generate a data message from the status information, and (iii) send the data message to the backup control device 28 over the Internet Protocol based network 16 for processing by the backup control device 28. In some example embodiments, the backup control device 28 is configured to (i) receive the data message over the IP network 16, and (ii) send a control signal to activate the backup radio frequency transmitter 26 based upon the data message.

The IP network 16 includes any Internet protocol based network, which may include the Internet, wide area networks, local area networks, enterprise networks, and the like, and any combinations thereof. The IP network 16 also includes networks which support Transmission Control Protocol/Internet Protocol (TCP/IP) based communications. The connection between the primary control device 22 and the backup control device 28 may also be provided via a virtual private network (VPN) over the IP network 16.

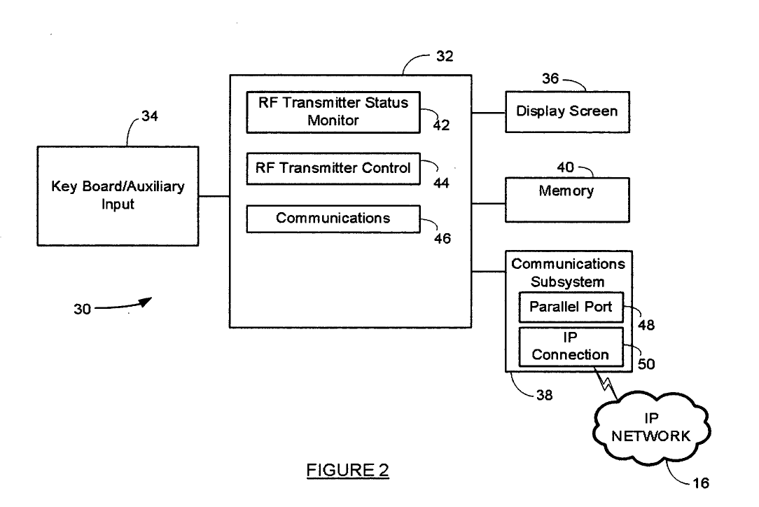

Reference is now made to FIG. 2, which shows a block diagram of a control device 30 to be used in the radio transmitter system 10 shown in FIG. 1. The control device 30 may be configured to operate either as the primary control device 22 or as the backup control device 28. In some example embodiments, the control device 30 is a conventional personal computer or server device configured with suitable software applications and hardware components. As shown in FIG. 2, the control device 30 has a controller 32 for controlling operation of the control device 30, a keyboard or auxiliary input 34, a display screen 36, and a communications subsystem 38 accessible by the controller 32 for communication to other devices. However, in some example embodiments, the keyboard or auxiliary input 34 and the display screen 36 may not be required for operation of the control device 30. The communications subsystem 38 includes a parallel port 48 which may be used to communicate with an RF transmitter (for example primary RF transmitter 20 or backup RF transmitter 26), and an IP connection 50 such as an Ethernet connection or wireless network card, which may be used for sending and receiving status information over the IP Network 16. The control device 30 also includes a memory 40, which is readable and accessible by the controller 32 and can include transient memory such as random access memory (RAM) and one or more persistent storage elements such as, but not limited to, flash memory or a hard drive. The controller 30 can also include one or more microprocessors that may access the persistent and/or transient memory 40. Memory 40 stores information and software enabling the microprocessor(s) of controller 32 to implement the control device 30 functionality as further described below.

Referring to both FIGS. 1 and 2, in example embodiments, the control device 30 may be connected to another similar control device which acts as a remote host (hereinafter “remote host”) via the IP Connection 50 over the IP network 16. The remote host may be connected to an associated remote RF transmitter. In such embodiments, the control device 30 acts as a “local host”. For example, from the view of the primary control device 22, the primary control device 22 would be the local host and the backup control device 28 would be the remote host. The primary RF transmitter 20 would be the local RF transmitter and the backup RF transmitter 26 would be the remote RF transmitter. From the view of the backup control device 28, the backup control device 28 would be the local host and the primary control device 22 would be the remote host. The backup RF transmitter 26 would be the local RF transmitter and the primary RF transmitter 20 would be the remote RF transmitter.

Referring again to FIG. 2, there are a number of modules of the controller 32 that may perform desired functions on the control device 30. In one example embodiment, the modules on controller 32 are implemented by software applications running on a processor of the controller 32, the executable code for such applications being stored in memory 40. As shown, the controller 32 has a RF Transmitter Status Monitor module 42, an RF Transmitter Control module 44, and a Communications module 46. Generally, the RF Transmitter Status Monitor module 42 is configured to monitor the status information of a local RF transmitter 20, 26 (FIG. 1). The RF Transmitter Control module 44 is configured to control a local RF transmitter 20, 26 (FIG. 1), for example by activating or de-activating (as appropriate) the local RF transmitter 20, 26. The Communications module 46 operates the communications subsystem 38. In various embodiments, additional or fewer modules may be implemented by controller 32, and some or all of the functions performed by some modules could be combined into other modules or split into separate modules.

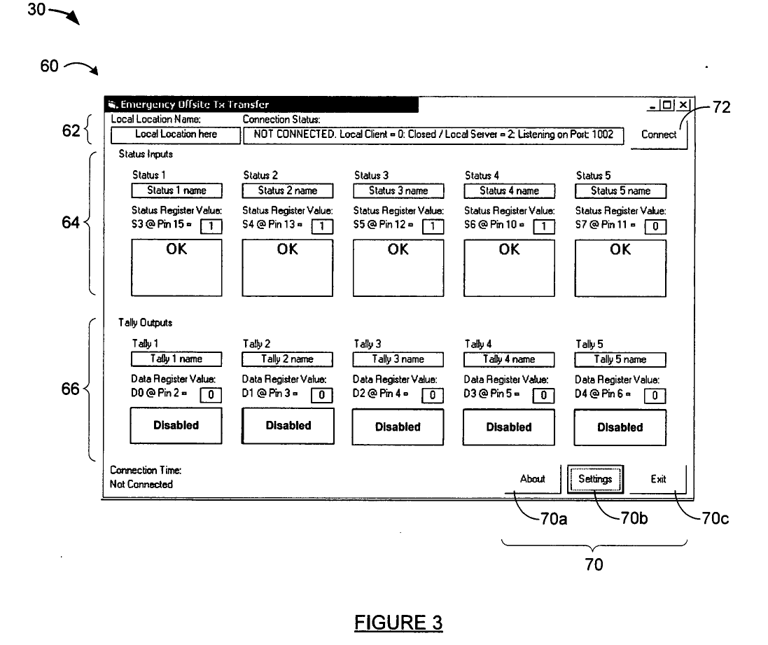

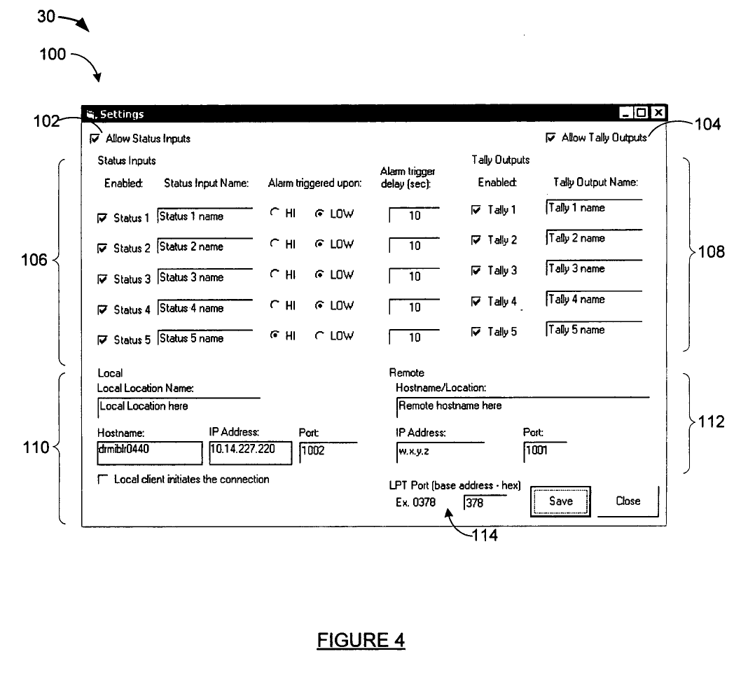

An example software application installable on the control device 30 will now be explained, with reference to FIG. 3, which shows an example graphical user interface screen shown on the display screen 36 (FIG. 2) of the control device 30. The graphical user interface screen displays a main environment or a main menu 60, which may be operated by a user to monitor a local RF transmitter 20, 26 (FIG. 1) and configure the functionality of the control device 30. As shown, the main menu 60 includes a Location sub-menu 62, a Status sub-menu 64, a Tally sub-menu 66, and other user-selectable icons 70. As shown, the user-selectable icons 70 include “About” 70a, “Settings” 70b, and “Exit” 70c. Referring briefly to FIG. 4, the selection of the “Settings” icon 70b causes the control device 30 to display a settings menu 100. The settings menu 100 permits the user to configure the control device 30, as will be explained in greater detail below.

Referring still to FIG. 3, as shown, the Location sub-menu 62 includes fields displaying a Local Location Name, a Connection Status, and a “Connect” icon 72. Generally, the Location sub-menu 62 indicates the name of the location of both the control device 30 and the remote host. Under “Local Location Name”, the location of the local control device 30 is displayed. Under “Connection Status”, the connection status, the name of the remote host, and the IP address of the remote host is displayed. If the user wishes to connect the remote host listed, the user selects the “Connect” icon 72.

The Status sub-menu 64 displays the status of a local RF transmitter 20, 26 (FIG. 1) connected to the control device 30. As shown, up to five test points may be monitored, each of which may be associated with a different RF transmitter (or test point on an RF transmitter). The status information of the five test points are represented as status inputs Status 1 to Status 5, respectively. The status information is interpreted by the control device 30 and an associated status value is generated. The possible status values are “OK”, “ALARM”, and “DISABLED”. “ALARM” represents a fault in the RF transmitter 20, 26. In the example shown, the status values for Status 1 to Status 5 are indicated as “OK”.

The “tally” features may for example be used when the control device 30 is operating as the backup control device 28 (FIG. 1). The Tally sub-menu 66 displays on the control device 30 the status values which are received by the control device 30 and a corresponding output control signal sent to a local RF transmitter 20, 26 (FIG. 1). In some example embodiments, up to five “tally” test points may be controlled by the control device 30, which may for example act as backup to the test points corresponding status inputs Status 1 to Status 5, described above. The status values sent by a remote host are received by the control device 30 over the IP Network 16. Once received by the control device 30, these status values are processed by the controller 32 (FIG. 2), and are displayed on the display screen 26 as Tally 1 to Tally 5, respectively (which would mirror the Status 1 to Status 5 values sent by the remote host). Depending on the status value received from the remote host, the possible Tally status values displayed are “OK”, “ALARM”, “DISABLED”, and “NO DATA/CORRUPT”. In the example shown, the Tally status values for Tally 1 to Tally 5 are indicated as “DISABLED”. The Tally sub-menu 66 is typically enabled if the control device 30 is used as the backup control device 28, and monitoring of the status values of the primary control device 22 is desired. The Tally status “NO DATA/CORRUPT” is for example displayed if no connection is established, or corrupt data has been received.

The status and tally features will now be further described, referring again to FIGS. 1 and 2. As described, the control device 30 may be connected to a local RF transmitter 18, 24 via the parallel port 48. For example, a parallel cable may be used. An appropriate *.dll or other driver application may be required for permitting communication with the parallel port 48, as is known in the art. The parallel port 48 may have a standard 25-pin configuration, with appropriate in/out registers. An example pin configuration in the parallel port 48 for the control device 30 may include the following:
Status Input 1=pin 15 (S3);
Status Input 2=pin 13 (S4);
Status Input 3=pin 12 (S5);
Status Input 4=pin 10 (S6);
Status Input 5=pin 11 (S7) (inverted);
Tally Output 1=pin 2 (D0);
Tally Output 2=pin 3 (D1);
Tally Output 3=pin 4 (D2);
Tally Output 4=pin 5 (D3); and
Tally Output 5=pin 6 (D4).

Note that pin 11 is inverted if a conventional parallel port is used, and this may be compensated for by the control device 30. Referring briefly to FIG. 3, if a pin of the parallel port 48 is at HIGH or +5 VDC, the Status sub-menu 64 or Tally sub-menu 66 would indicate that the respective “pin=1”, as shown. If a pin of the parallel port 48 is at LOW or 0 VDC, the Status sub-menu 64 or Tally sub-menu 66 would indicate that the respective “pin=0”, as shown (note that Status 5 indicates “pin 11=0” because pin 11 is inverted).

Referring still to FIGS. 1 and 2, in order for the control device 30 to determine the status of a local RF transmitter 18, 24, one of the Status Input pins of the parallel port 48 may be connected to an appropriate test point on the RF transmitter 18, 24. The test point may for example be provided with an RF-activated relay (not shown). When an RF signal is present or exceeds a predetermined RF power threshold in the RF transmitter 18, 24, the RF-activated relay provides an open circuit, and thereby a HIGH or +5 VDC is input into the appropriate Status Input pin in the parallel port 48 (and the main menu 60 (FIG. 3) would display the respective “pin=1”). When an RF signal is lost or below the predetermined RF power threshold, the RF-activated relay activates and provides a ground, generating a LOW or 0 VDC to the Status Input pin (and the main menu 60 (FIG. 3) would display the respective “pin=0”). In some example embodiments, the Status Input pins may be electrically isolated from the RF-activated relay and RF transmitter 18, 24, for example using optical couplers.

As mentioned, the status information received from the test points are displayed as status values on the display screen 36, as Status 1 to Status 5, respectively, on main menu 60 (FIG. 3). The control device 30 may then send each of the status values to the remote host via the IP network 16. An appropriate *.ocx or other driver application may be required for sending and receiving this information over the IP network 16. A TCP/IP protocol may also be used for facilitating communications. As mentioned, the possible status values are “OK”, “ALARM”, and “DISABLED”. Other information such as the name of the control device 30 and associated IP address may also be transmitted. An example syntax for a data message sent to a remote host is as follows:
<Status1>;<Status2>;<Status3>;<Status4>;<Status5>;<# of characters in local EOTT IP address>;<local EOTT IP address>;<local EOTT location name>.

A control device 30 which acts as the remote host and receives this data message would process the incoming status values in its controller 32. As mentioned, these status values are displayed on the display screen 36 as Tally 1 to Tally 5 on main menu 60 (FIG. 3). The Tally Output pins are based on an interpretation of this incoming data message. In some example embodiments, the Tally Output pins is connected to a relay (not shown) for activating an associated RF transmitter 20, 26 (FIG. 1). In other example embodiments, the Tally Output pins are used as a control signal input into a metering and control system, which subsequently uses the control signal to activate the RF transmitter 20, 26 (FIG. 1). An example metering and control system is the GSC3000, available from Gentner (now Burke Technology Inc.). If a particular status value is in an ALARM condition, the appropriate Tally Output pin provides a HI or +5 VDC output which acts as a control signal to activate a local RF transmitter 20, 26 (and the main menu 60 (FIG. 3) would display the respective “pin=1”). Conversely, if a status value is DISABLED or OK, the Tally Output pin provides a LOW or 0 VDC (and the main menu 60 (FIG. 3) would display the respective “pin=0”). If no connection is established, or corrupt data has been received (i.e., status value is NO DATA/CORRUPT), a LOW or 0 VDC is provided at the Tally output pin. In a HI or +5 VDC state, the Tally Output pins provide a control signal which is thereby used to activate a local RF transmitter 18, 24.

Additional features of the control device 30 will now be explained, with reference to FIG. 4, which shows a settings menu 100 shown on the display screen 36 of the control device 30. The settings menu 100 may for example be accessed by selecting the Settings 70b (FIG. 3) user-selectable icon. As shown, the settings menu 100 includes an Allow Status Inputs toggle 102, an Allow Tally Outputs toggle 104, a Status Inputs interface 106, a Tally Outputs interface 108, a Local host interface 110, a Remote host interface 112, and a parallel port interface 114.

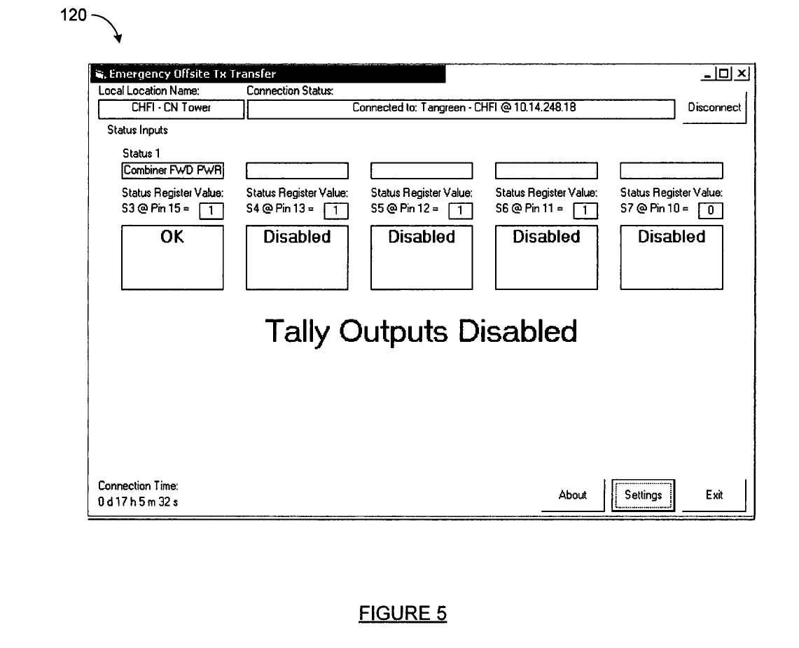

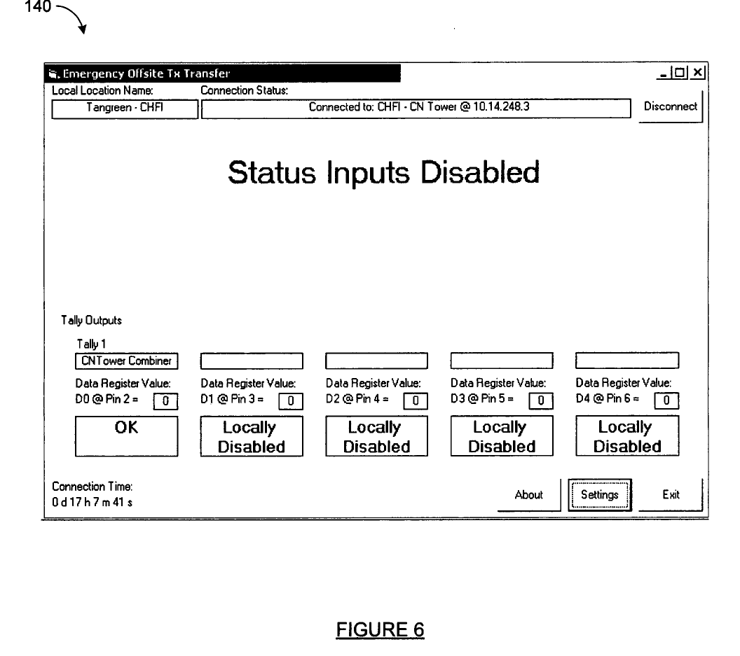

The Allow Status Inputs toggle 102 permits the user to enable or disable whether the control device 30 will send the status values (from the data message as described above) to the remote host over the IP network 16. Referring briefly to FIG. 6, if the Allow Status Inputs toggle 102 is disabled, the graphical user interface screen 140 will indicate “Status Inputs Disabled”, as shown, or some other indicator. The Allow Tally Outputs toggle 104 permits the user to enable or disable whether the control device 30 will accept or process the received status values from the remote host over the IP network 16. Referring briefly to FIG. 5, if the Allow Tally Outputs toggle 102 is disabled, the graphical user interface screen 120 will indicate “Tally Outputs Disabled”, as shown, or some other indicator.

The Status Inputs interface 106 may be used to configure the specific status inputs and consists of enabling/disabling the status inputs, naming the status inputs (for example, to a maximum 16 characters), choosing how an alarm is to be triggered, and determining the amount of time to delay before the alarm is sent to a remote host. The options selected in the Status Inputs interface 106 would also be reflected in the main menu 60 (FIG. 3). As shown in FIG. 4, with respect to the enabled Status Input checkmarks boxes, this allows a user to enable or disable a specific status input, corresponding to a test point. With respect to the Status Input Name, this allows a user to name a specific channel. With respect to “Alarm triggered upon”, this allows a user to select whether the status information of the status input should be triggered upon a HI or LOW signal. With respect to “Alarm trigger delay (sec)”, this allows a user to enter a positive integer representing a predetermined delay time in seconds. The delay time represents a buffer time between the point that an alarm status is read by the control device 30 and sent to a connected remote host over the IP network 16. For example, the primary transmitter site 12 may have an on-site backup transmitter which may have a fail over time of 30 seconds. An appropriate delay time for the control device 30 in this example could be 35 seconds, to ensure that the primary transmitter site 12 has completely failed, after which an ALARM status value would be sent to the backup transmitter site 14 for the purposes of activating the backup transmitter site 14.

The Tally Outputs interface 108 may be used to configure the specific tally outputs and consists of enabling/disabling the tally outputs and naming the tally outputs (for example, to a maximum 16 characters). The options selected in the Tally Outputs interface 108 would also be reflected in the main menu 60 (FIG. 3).

The Local host interface 110 generally allows a user to configure the local location name of the control device 30 and the IP port to be configured. The local location name is a descriptive field as entered by the user. In some example embodiments, the hostname and IP Address fields are automatically populated according to the systems configuration or for example in a profile as stored in memory 40 (FIG. 2). This information may also be passed onto the remote host over the IP network 16. The checkbox in the Local host interface 110 indicates which device (either the control device 30 or the remote host) initiates the connection. If this checkbox is enabled, another sub-menu (not shown) may be displayed with the option of “Auto Reconnect every x seconds”. When enabled, and if not already connected to a remote host, the control device 30 will attempt an automatic reconnect to the remote IP address and port for the time interval indicated.

The Remote host interface 112 allows the remote host name to be configured, which may be a convenient local name entered by a user of the control device 30. The remote IP Address and remote IP Port may also be entered into the respective field if the control device 30. If this information is entered, the control device 30 would thereby configured to identify which remote host it is waiting or ‘listening’ on. Thus, in such example embodiments, the control device 30 and remote host may be configured for each other's specific IP address and IP port.

The parallel port interface 114 includes a field having the base address in hex of the desired parallel port 48 (FIG. 2). In some embodiments, the field may be manually populated by for example accessing the device manager of the control device 30. In other embodiments, the field may be automatically populated, for example retrieved from the systems configuration or a profile stored in memory 40 (FIG. 2).

An example operation of the transmitter system 10 will now be described with reference to FIGS. 1, 5 and 6. FIG. 5 shows the main menu 60 of FIG. 3 when operating as the primary control device 22, and is illustrated as graphical user interface screen 120. FIG. 6 shows the main menu 60 of FIG. 3 when operating as the backup control device 28, and is illustrated as graphical user interface screen 140.

Referring now to FIGS. 1 and 5, the location name of the primary control device 22 at the primary transmitter site 12 is shown on the graphical user interface screen 120 as “CHFI-CN Tower”. The Connection Status field displays the connection status and location of the backup control device 28, and is shown as “Connected to: Tangreen-CHFI @ 10.14.248.18”. Also shown, the Status 1 is enabled and the corresponding status value is shown as “OK”. The “OK” indicates that a HIGH or +5 VDC (or similar status information) has been received by the primary control device 22. The remaining status values Status 2 to Status 5 are indicated as “DISABLED”, which were disabled by the user, for example by configuring the Status Inputs interface 106 (FIG. 3). The tally outputs have also been disabled by the user, for example by configuring the Allow Tally Outputs toggle (FIG. 4). Accordingly, a “Tally Outputs Disabled” message is displayed.

Referring still to FIGS. 1 and 5, in some example embodiments, the primary control device 22 sends to the backup control device 28 the status values on a periodic time interval, for example every 3 seconds (also referred to as continuous polling control). In other example embodiments, the primary control device 22 sends to the backup control device 28 the status values only in the circumstance of a change in any status value (also referred to as interrupt control). In the example of FIG. 5, the primary control device 22 sends to the backup control device 28 the status values every 3 seconds. Using a data message having an example syntax described above, the status values would be sent over the IP network 16 in a data message as follows:
<OK>;<DISABLED>;<DISABLED>;<DISABLED>;<DISABLE D>;<11>;<10.14.248.3>;<CHFI-CN Tower>.

Referring now to FIGS. 1 and 6, the location name of the backup control device 28 at the backup transmitter site 14 is shown on the graphical user interface screen 140 as “Tangreen-CHFI”. The Connection Status field is shown as “Connected to: CHFI-CN Tower @ 10.14.248.3”. As shown, the Tally 1 is enabled and the corresponding tally status value is shown as “OK”. As shown, the remaining tally status values Tally 2 to Tally 5 indicate “Locally Disabled”, that is, disabled by the primary control device 22. The status inputs of the backup control device 28 are also shown as disabled by the user, for example by configuring the Allow Status Inputs toggle 102 (FIG. 4). Accordingly, a “Status Inputs Disabled” message is displayed.

Referring still to FIGS. 1 and 6, the backup control device 28 receives the example data message as described above. The backup control device 28 interprets the “OK” status value with respect to Status 1, and responds by sending a LOW or 0 VDC control signal to the backup RF transmitter 26. In other words, the backup RF transmitter 26 is maintained in a non-activated state or is de-activated (if presently active), based on the status information that the primary RF transmitter 20 is “OK”. The backup control device 28 also interprets the “DISABLED” message with respect to Status 2 to Status 5, and responds by sending a LOW or 0 VDC control signal to the backup RF transmitter 26. If an “ALARM” message is received, this means that a fault was detected by the primary control device 22 and sent to the backup control device 28 over the IP network 16. The backup control device 28 processes the received information and responds by sending a HIGH or +5 VDC at the appropriate output pin, thereby activating the backup RF transmitter 26.

It can be appreciated that in some example embodiments, both the primary control device 22 and the backup control device 28 may have both the status inputs enabled and the tally outputs enabled, thereby creating a two-way conversation between the respective devices.

It can also be appreciated that since the processing may be performed by a control device 30 at both the primary transmitter site 12 and the backup transmitter site 14, a central server or transmitter switching mechanism may not be required for operation.

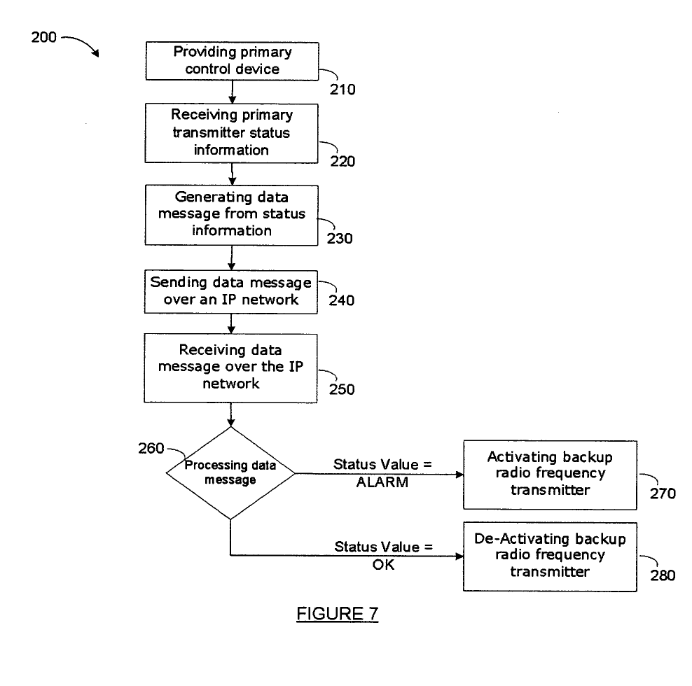

Reference is now made to FIG. 7, which shows a method 200 in accordance with an example embodiment. The method is for activating a backup radio frequency transmitter based upon a status of a primary radio frequency transmitter, the backup radio frequency transmitter being controllable by a backup control device. At step 210, the method 200 comprises providing a primary control device. At step 220, the primary control device is receiving from the primary radio frequency transmitter status information relating to the primary radio frequency transmitter. At step 230, the primary control device is generating a data message based upon the status information. The data message includes status values corresponding to the status information. At step 240, the primary control device is sending the data message to the backup control device over an Internet Protocol based network, for processing by the backup control device. At step 250, the backup control device is receiving the data message over the Internet Protocol based network. At step 260, the backup control device is processing the data message and makes a decision based on the status information. At step 270, if a status value is equal to an “ALARM” state, the backup control device responds by sending a control signal for activating the backup radio frequency transmitter. At step 280, if a status value is equal to an “OK” state, the backup control device responds by sending a control signal for de-activating the backup RF transmitter (or maintaining at a de-activated state, as appropriate). The method 200 may be repeated, as appropriate. It can be appreciated that each step in the method 200 may not be necessary for operation, and may have more or less steps may be implemented depending on the particular application.

Although an alarm state has been described with respect to the RF power decreasing below a predetermined RF power threshold, the alarm state can represent any suitable property of the RF transmitter which may be used to determine a fault. For example, referring to FIG. 2, the input pins of the parallel port 48 may receive a signal from an audio detector (not shown) associated with the RF transmitter, wherein the audio detector would detect whether an audio signal or silence is being transmitted in the RF transmitter. In another example, the input pin may receive a power signal from a generator which provides power for operation of the RF transmitter. The input pin would be receiving a signal dependent on whether an appropriate power level is provided to power the RF transmitter. Referring now to FIG. 4, in such embodiments, a user may configure the Status Inputs interface 106 and Tally Outputs interface 108, to change the Status Input name and/or Tally Output name to an appropriate name to correspond to the property being monitored by the status input.

Although a primary transmitter site and backup transmitter site have been described, it can be appreciated that the terms “primary” and backup” have been used for convenience. For example, in some embodiments, once a primary transmitter site fails and a backup transmitter site is activated, the backup transmitter site may in fact become the primary transmitter site, while the original primary transmitter site acts as the backup. In addition, as described above, two-way conversations may be implemented as between the primary transmitter site and the backup transmitter site.

While the invention has been described in detail in the foregoing specification, it will be understood by those skilled in the art that variations may be made without departing from the scope of the invention, being limited only by the appended claims.

What is claimed is:

1. A method for activating a backup radio frequency transmitter based upon a status of a primary radio frequency transmitter, the backup radio frequency transmitter being controllable by a backup control device, the method comprising:
providing a primary control device;
receiving in the primary control device from the primary radio frequency transmitter status information relating to the primary radio frequency transmitter;
generating a data message from the status information; and
sending the data message to the backup control device over an Internet Protocol based network for processing by the backup control device.

2. The method of claim 1, further comprising the step of:
receiving the data message in the backup control device over the Internet Protocol based network; and
activating the backup radio frequency transmitter using a control signal from the backup control device based upon the data message.

3. The method of claim 1, wherein the data message includes status values corresponding to the status information.

4. The method of claim 1, further comprising the steps of:
determining from the status information whether the primary radio frequency transmitter is in an alarm state;
waiting for a predetermined time delay; and
sending, if the primary radio frequency transmitter is in an alarm state after the predetermined time delay, the status information in an alarm state to the backup control device.

5. The method of claim 1, wherein the step of sending the status information to the backup control device over an Internet Protocol based network is performed on a periodic time interval.

6. The method of claim 1, wherein the step of sending the status information to the backup control device is performed based on a change in the status information.

7. The method of claim 1, further comprising the step of sending address information of the primary control device to the backup control device over the Internet Protocol based network.

8. The method of claim 1, further comprising the step of initiating an Internet Protocol connection for communication between the primary control device and the backup control device over the Internet Protocol based network.

9. The method of claim 1, wherein the Internet Protocol based network comprises a Transmission Control Protocol/Internet Protocol (TCP/IP) based network, and wherein the step of sending the status information to the backup control device over an Internet Protocol based network is implemented using TCP/IP.

10. The method of claim 1, wherein the primary radio frequency transmitter is located geographically remote from the backup radio frequency transmitter.

11. The method of claim 1, wherein the primary radio frequency transmitter broadcasts to generally the same geographical region as the backup radio frequency transmitter.

12. The method of claim 1, wherein the status information includes information based on whether a radio frequency signal exceeds a predetermined radio frequency power threshold.

13. A system for activating a backup radio frequency transmitter based upon a status of a primary radio frequency transmitter, comprising:
a primary control device associated with the primary radio frequency transmitter;
a backup control device for controlling the backup radio frequency transmitter and in communication with the primary control device over an Internet Protocol based network;
wherein the primary control device is configured to (i) receive from the primary radio frequency transmitter status information relating to the primary radio frequency transmitter, (ii) generate a data message from the status information, and (iii) send the data message to the backup control device over the Internet Protocol based network for processing by the backup control device.

14. The system of claim 13 wherein the backup control device is configured to (i) receive the data message over the Internet Protocol based network, and (ii) send a control signal to activate the backup radio frequency transmitter based upon the data message.

15. A local control device associated with a local radio frequency transmitter and configured for communication with a remote control device associated with a remote radio frequency transmitter, the local control device comprising:
a controller for controlling the operation of the local control device; and
a communications interface accessible by the controller and configured for communication with the local radio frequency transmitter and configured for communication with an Internet Protocol based network, the controller configured to:
receive from the local radio frequency transmitter status information relating to the local radio frequency transmitter,
generate a data message from the status information, and
send the data message to the remote control device over the Internet Protocol based network for processing by the remote control device.

16. The local control device of claim 15, wherein the controller is further configured to:
receive from the remote control device the data message over the Internet Protocol based network, and
send a control signal to activate the local radio frequency transmitter based upon the data message.

17. The local control device of claim 15, wherein the controller is further configured to:
receive from the remote control device status information relating to the remote radio frequency transmitter over the Internet Protocol based network, and
send a control signal to de-activate the local radio frequency transmitter based upon the status information relating to the remote radio frequency transmitter.

18. The local control device of claim 15, wherein the data message includes status values corresponding to the status information.

19. The local control device of claim 15, wherein the controller is further configured to:
determine from the status information whether the local radio frequency transmitter is in an alarm state;
wait for a predetermined time delay; and
send, if the local radio frequency transmitter is in an alarm state after the predetermined time delay, the status information in an alarm state to the remote control device.

20. The local control device of claim 18, further comprising a display, wherein the controller is configured to display on the display the status value corresponding to the status information of the local radio frequency transmitter.

21. The local control device of claim 15, wherein the Internet Protocol based network comprises a Transmission Control Protocol/Internet Protocol (TCP/IP) based network.

22. The method of claim 15, wherein the local radio frequency transmitter is located geographically remote from the remote radio frequency transmitter.

23. The method of claim 15, wherein the primary radio frequency transmitter broadcasts to generally the same geographical region as the backup radio frequency transmitter.

24. The local control device of claim 15, wherein the status information includes information based on whether a radio frequency signal exceeds a predetermined radio frequency power threshold.

25. A computer readable memory having recorded thereon instructions for execution by a local control device associated with a local radio frequency transmitter, the local control device configured for communication with a remote control device associated with a remote radio frequency transmitter, the instructions including instructions to:
receive from the local radio frequency transmitter status information relating to the local radio frequency transmitter,
generate a data message from the status information, and send the data message to the remote control device over an Internet Protocol based network for processing by the remote control device.
